(19) United States
(12) Patent Application Publication
(10) Pub. No.: US 2007/0124549 A1
(43) Pub. Date: May 31, 2007

(54) Interface setting method

(76) Inventor: Takashi Hiramatsu, Osaka (JP)

Correspondence Address: MCDERMOTT WILL & EMERY LLP, 600 13TH STREET, N.W., WASHINGTON, DC, 20005-3096, US

(21) Appl. No.: 11/600,856

(22) Filed: Nov. 17, 2006

(30) Foreign Application Priority Data
Nov. 25, 2005 (JP) 2005-340115

(51) Int. Cl. G06F 13/00

(52) U.S. Cl. 711/154

(57) ABSTRACT

An interface-specification setting register is provided to the device; a prescribed interface specification is set in the interface-specification setting register by software control through a processor; and, thereafter, the device is operated with the interface specification that is set in the interface-specification setting register.

### BACKGROUND OF THE INVENTION

1. Field of the Invention

The present invention relates to an interface setting method for a semiconductor integrated circuit and, more specifically, to a technique for connecting a processor and a device whose interface specifications (endian type and bus type) are different form each other.

In connecting a CPU (Central Processing Unit) as a typical example of a processor and a device that is controlled by the CPU in a semiconductor integrated circuit, it is necessary to connect them by considering the bus types and the endian types of data of them respectively. “Endian” is also referred to as byte order. When recording or transferring numeric data that has a data amount of 2 bytes or more, the numeric data is divided into segments of 1 byte. Endian type shows the execution order (the order of arranging the higher and lower bytes of the data) of recording/transfer at that time.

There are two types in the bus types of the CPU. One of the types is a separate type with which address signals and data signals outputted from the CPU are outputted from separate terminal groups respectively, and the other is a multiplex type in which the address signals and the data signals are both outputted from the same terminal group. There are also two types in the endian systems. One of the types is the so-called big-endian mode in which the high-order byte of data is stored in the low-order byte in a data register of the CPU, and the low-order byte of the data is stored in the high-order byte respectively. The other type is the so-called little-endian mode in which the high-order byte of the data is stored in the high-order byte in the data register of the CPU, and the low-order byte of the data is stored in the low-order byte respectively. In the big-endian mode, recording/transmission is carried out in order from the most significant byte, whereas the recording/transmission is carried out in order from the least significant byte in the little-endian mode. There are two kinds of method for storing nibbles (a half the byte) in the CPU. One of the methods is to store the high-order nibble of data to the low-order nibble of the data register of the CPU, and store the low-order nibble of the data to the high-order nibble. The other method is to store the high-order nibble of the data to the high-order nibble, and store the low-order nibble of the data to the low-order nibble. Each manufacture of CPUs determines the arranging order of the data terminals freely.

In the connecting technique for the semiconductor integrated circuit where bus types and data endian types are different, it is desired to reduce the number of external circuits as much as possible, not to wastefully use the terminals of the semiconductor integrated circuit, to avoid long distribution of the substrate wirings, to avoid deterioration of the performance, etc.

Hereinafter, description will be given to the currently wide-use technique for performing mutual connection in the semiconductor integrated circuit-in which the bus types and the endian types are different. FIG. 14 illustrates connections when connecting a CPU and a device which are the same bus type and the same data endian type respectively. In FIG. 14, reference numeral 81 is a CPU, 82 is a device that is controlled by the CPU 81, which has the same endian type and bus type, 83 indicates address output terminals of the CPU 81, 84 indicates the address signal lines on the substrate, 85 indicates address input terminals of the device 82, 86 indicates data input/output terminals of the CPU 81, 87 indicates data signal lines on the substrate, and 88 indicates data input/output terminals of the device 82. In general, as the connection targets, there are not only the address and the data but also, for example, enabling signals, interrupt signals, acknowledge signals between the CPU and the device. However, those other than the address and the data are omitted here.

The address signals outputted from the address output terminals of the CPU 81 are supplied to the address input terminals 85 of the device 82 through the address signal lines 84. The data signals outputted from the data input/output terminals 86 of the CPU 81 are supplied to the data input/output terminals 88 of the device 82 through the data signal lines 87. The data signals are two-way signals, so that they may also be outputted from the device 82. In that case, the data signals are outputted from the data input/output terminals of the device 82, which are supplied to the data input/output terminals 86 of the CPU 81 through the data signal lines 87. In the CPU 81, the data and the address are separated to terminals 83 and 86. Thus, the address is supplied as the address and the data is supplied as the data to the device 82, which-means that the CPU 81 and the device 82 are the same bus type (separate type) Furthermore, the endian type of the data of the CPU 81 is the same as that of the device 82. Thus, for the data signal lines 87, the most-significant bit of the data input/output terminals 86 of the CPU 81 is connected to the most-significant bit of the data input/output terminals 88 of the device 82 and, thereafter, the bit of the data input/output terminals 86 and the bit of the data input/output terminals 88 are connected until the leas-significant bit in a descending order.

FIG. 15 shows the connection state where a CPU and a device having the same bus type and different data endian type are connected. In FIG. 15, reference numeral 82a is the device having the same bus type as the CPU 81 and different endian type from it. For the connection of the address signals, it is the same as the case of FIG. 14 described above, because the bus type of the CPU 81 and that of the device 82a are the same (separate type). The data signals outputted from the data input/output terminals 86 of the CPU 81 are supplied to data input/output terminals 88a of the device 82a through the data signal lines 87. Since the data endian type of the CPU 81 and that of the device 82a are different, the data signal lines 87 are connected in a crosswise manner. As a connecting method in this case, when each of the CPU 81 and the device 82a has the data width of 32 bits, for example, signals outputted from 0th bit-7th bit of the CPU 81 are connected to 24th bit-31st bit of the data of the device 82a, signals outputted from 8th bit-15th bit of the data of the CPU 81 are connected to 16th bit-23rd bit of the data of the device 82a, signals outputted from 16th bit-23rd bit of the data of the CPU 81 are connected to 8th bit-15th bit of the data of the device 82a, and signals outputted from 24th bit-31st bit of the data of the CPU 81 are connected to 0th bit-7th bit of the data of the device 82a. Like this, it is necessary to inverse the arranging order of bytes of data on the CPU 81 side and the device 82a side. Thus, the data signal lines 87 are going to cross on the substrate.

FIG. 16 also shows an example of the different connection from the one shown in FIG. 15 state in the case where a CPU and a device having the same bus type and different data endian type are connected. In FIG. 16, reference numeral 82a is the device having the same bus type as the CPU 81 (separate type) and different endian type from it, 88a indicates data input/output terminals of the device 82a, 89 is an endian-type changing input/output terminal for changing the data endian type of the device 82a, and 90 is an input signal line connected to the endian-type changing input/output terminal 89. For connection of the address signals, it is the same as those described in FIG. 14 and FIG. 15. For connection of the data signals, although the endian type of the CPU 81 and that of the device 82a are different, it is unnecessary to cross the data signal lines 87 on the substrate and the lines can be connected in the same manner as that of FIG. 14 because the endian type can be changed by a function of the endian-type changing input/output terminal 89. Though the endian-type changing input terminal 89 is fixed at a given value by the input signal line 90, a circuit that is capable of changing the endian type to big-endian mode or little-endian mode depending on that value, is mounted. Therefore, there is no crossing of the data connection lines generated on the substrate as in FIG. 15. Alternatively, a terminal is added to the outside the device 82a.

FIG. 17 also shows an example of the different connection from the one shown in FIG. 15 and 16 in the case where a CPU and a device having the same bus type and different data endian type are connected. In FIG. 17, reference numeral 82a is the device having the same bus type as the CPU 81 (separate type) and different endian type from it. For both the address signals and the data signals, the connecting methods are the same as those described in FIG. 14, except that there is no endian-type changing input terminal that is shown in FIG. 16. In this case, every time the CPU 81 and the device 82a exchange data, the high-order byte and the low-order byte of the data are switched on software. By doing so, it is possible to achieve data communication between the devices which have different endian types. In practice, data endian type is changed through consuming several clock cycles or several tens of clock cycles in some cases at every data access.

FIG. 18 shows an example of the different connection from the one shown in the case where a CPU and a device having different bus types and the same data endian type are connected. In FIG. 18, reference numeral 81a is a multiplex-type CPU, 82 is a device having different bus type from the CPU 81a (separate type) and the same endian type, 83a is an address-strobe-signal output terminal, 91 is an output signal line for inputting the value of the address-strobe-signal output terminal 83a to a latch circuit 92 described later, 92 is a latch circuit for latching the address part of an address/data signal lines 87 described later, 86a indicates address/data input/output terminals of the CPU 81a, and 87a indicates address/data signal lines. The address/data signals outputted from the address/data input/output terminals 86a are inputted to the data input/output terminals 88 through the address/data signal lines 87a. The address/data signals are also inputted to the latch circuit 92. From the address/data input/output terminals 86a, address is outputted at a given point and data is outputted at another point. At a point where the address is outputted, an address strobe signal is outputted from the address-strobe-signal output terminal 83a. The output is inputted to the latch circuit 92 through an output signal line 91, and the latch circuit 92 latches the value of the address from the address/data signal line 87a. The value of the address latched by the latch circuit 92 is supplied to the address input terminals 85 through the signal lines 84. The data is supplied to the data input/output terminals 88 through the address/data signal lines 87a. When the values of the signal lines 84 and the values of the address/data signal lines 87a become constant, the device 82 fetches each value. By doing so, it becomes possible to achieve data communication between the CPU and the device whose bus types are different.

FIG. 19 shows the connection in a case where a CPU and a device having different bus types and different data endian type each other are connected. In FIG. 19, reference numeral 81a is a multiplex-type CPU, 82a is a device that has different bus type (separate-type) and different endian type from the CPU 81a, and 88a indicates the data input/output terminals of the device 82a. Input of the address is carried out in the same manner as that described in FIG. 18. Input/output of data is carried out in the same manner as that described in FIG. 15.

These mutual connection techniques are effective for connecting the CPU and the device whose bus types are different from each other, and used widely in these days. Further, examples of other connection techniques for a semiconductor integrated circuit having different bus types and different endian types are the ones described in Japanese Patent Literature 1 (Japanese Unexamined Patent Publication 3-160550: Endian type conversion system), Japanese Patent Literature 2 (Japanese Unexamined Patent Publication 8-305628: Endian type conversion device with automatic judging function and method thereof) and Japanese Patent Literature 3 (Japanese Unexamined Patent Publication 2004-13943: Interface circuit in semiconductor device).

In those methods, however, an increase in the number of external circuits, wasteful use of the terminals of the semiconductor integrated circuit, deterioration of performance, and wiring congestion on the substrate cannot be avoided. Thus, those techniques are not the connection techniques that can satisfy all the desired good conditions at the same time.

### SUMMARY OF THE INVENTION

The main object of the present invention, therefore, is to provide a technique that can ease an increase in the number of external circuits, wasteful use of the terminals of the semiconductor integrated circuit, deterioration of performance, wiring congestion on the substrate and the like for connection of a semiconductor integrated circuit whose interface specifications such as the bus types and endian types are different.

In order to overcome the aforementioned issues, the interface setting method according to the present invention is a method for setting interface specifications between a processor and a device that is controlled by the processor, with the device having a plurality of kinds of interface specifications, wherein:

an interface-specification setting register is provided to the device; a prescribed interface specification is set to the interface-specification setting register by software control through the processor; and, thereafter, the device is operated with the interface specification that is set in the interface-specification setting register.

According to this, the processor and the device can be interfaced while being aligned to the interface specifications of the processor such as a CPU, since the interface-specification setting register is provided to the device, and the interface specification is set thereafter in the register through software by the control from the processor. Thus, it is possible to exchange data between the processor and the device regardless of the type of data received from the processor, through setting the interface specification to the register of the processor only once right after release of hardware reset of the processor and the device; fixing that state thereafter; and making an access to the device by the interface specification that is matched with that of the processor. At that time, it is unnecessary to add an external circuit or a special terminal, and to modify the wirings on the substrate.

There is such an embodiment that an endian-type setting register for setting an endian type of data as the interface specification is used as the interface-specification setting register; and the endian type is set in the endian-type setting register through software control performed based on data access of the processor.

In this structure, it is preferable to carry out setting of the endian type by writing data array that is not affected by the endian type, to the endian-type setting register.

According to this, the following effects can be achieved when connecting the processor and the device having different endian types from each other.
an external circuit is unnecessary
unnecessary to align the endian type through crossing of the wirings on the substrate
unnecessary to change the endian type of the data on software every time the processor has an access to the device through software
unnecessary to add a terminal for changing the endian type

Further, there is such an embodiment that a nibble-arranging-order setting register that sets nibble arranging order of data as the interface specification is used as the interface-specification setting register; and the nibble arranging order is set in the nibble-arranging-order setting register through software control performed based on data access of the processor.

In this structure, it is preferable to carry out setting of the nibble arranging order of data by writing data array that is not affected by the nibble arranging order, to the nibble-arranging-order setting register.

According to this, the following effects can be achieved in connecting the processor and the device having different nibble-arranging-orders of data from each other.
an external circuit is unnecessary
unnecessary to align the nibble-arranging-order of data through crossing of the wirings on the substrate
unnecessary to change the nibble-arranging-order of the data based on software every time the processor has an access to the device through software
unnecessary to add a terminal for changing the nibble-arranging-order of data

Further, there is such an embodiment that an ascending/descending order setting register that sets ascending/descending order of bits of data as the interface specification is used as the interface-specification setting register; and the ascending/ descending order of bits of data is set in the ascending/descending order setting register through software control performed based on data access of the processor.

In this case, it is preferable to carry out setting of the ascending/descending order of bits of data by writing data array that is not affected by the ascending/ descending order of bits of data, to the ascending/descending order setting register.

According to this, the following effects can be achieved in connecting the processor and the device having different ascending/descending orders of bits of data from each other.
an external circuit is unnecessary
unnecessary to align the ascending/descending order of bits of data through crossing of the wirings on the substrate
unnecessary to change the ascending/descending order of bits of the data based on software every time the processor has an access to the device through software
unnecessary to add a terminal for changing the ascending/descending order of bits of data

Furthermore, there is such an embodiment that a bus-type setting register that sets bus type of address/data as the interface specification is used as the interface-specification setting register; and the bus type of address/data is set in the bus-type setting register through software control performed based on data access from the processor.

In this structure, it is preferable: to use an arbitrary register having an address that can be expressed as the interface specification by eliminating a bit from an address signal width of the device as the bus-type setting register; and to write a data array for setting a bus type of the device to either a separate type or a multiplex type onto the bus-type setting register.

According to this, the following effects can be achieved in connecting the processor and the device having different bus types of address/data from each other.
an external circuit is unnecessary
unnecessary to align the bus type through modifying the wirings on the substrate
unnecessary to mount a latch circuit on the substrate for keeping the address value

In this structure, there is such an embodiment that set value thereof is kept in the bus-type setting register when the bus type is set to the multiplex type in the bus-type setting register, and update of the set value is carried out thereafter only with hardware reset. According to this, it is possible to avoid such inconvenience that the value of the bus-type register is changed every time the processor has data access to the device.

Furthermore, there is such an embodiment that a set value in the interface-specification setting register is confirmed by using a setup confirmation register of the device. According to this, the current setting state can be known by reading out the values of the setup confirmation register.

Moreover, there is such an embodiment that a bit that is irrelevant to designation of address of the bus-type setting register is used as an address strobe signal outputted by the processor when the device is used as the multiplex type. According to this, an increase in the number of terminals of the device can be suppressed.

Further, there is such an embodiment that at least two registers are used as the interface-specification setting register among the endian-type setting register for setting the endian type of data, the nibble-arranging-order setting register for setting the nibble arranging order of data and the ascending/descending order setting register for setting the ascending/descending order of bits of data; and when the values of at least two registers are changed, the setup confirmation register sets values that are not consistent with each other in accordance with changes in the values of at least two registers, and keeps the set values even in hardware reset and software reset. According to this, it means that the setup confirmation register is made into a register to which writing is prohibited, so that the current set value can be known without fail.

According to the present invention, in connecting the processor and the device having different interface specifications such as endian types or bus types, it is unnecessary to add an external circuit. Furthermore terminals of the processor and the device are not used wastefully, it is unnecessary to modify the wirings on the substrate, and the execution performance of the software is not deteriorated.

The interface setting method according to the present invention is effective as a technique for connecting the processor such as a CPU and the device having the different endian types and bus types respectively.

### BRIEF DESCRIPTION OF THE DRAWINGS

Other objects of the present invention will become clear from the following description of the preferred embodiments and the appended claims. Those skilled in the art will appreciate that there are many other advantages of the present invention by embodying the present invention.

FIG. 1 is a circuitry diagram for describing an interface setting method for a semiconductor integrated circuit according to a first embodiment of the present invention;

FIG. 2 is a first illustration showing values to be written to an endian-type setting register according to the first embodiment;

FIG. 3 is a second illustration showing values to be written to an endian-type setting register according to the first embodiment;

FIG. 4 is a first illustration showing values to be written to a nibble-arranging-order setting register according to the first embodiment;

FIG. 5 is a second illustration showing values to be written to the nibble-arranging-order setting register according to the first embodiment;

FIG. 6 is a first illustration showing values to be written to an ascending/descending order setting register according to the first embodiment;

FIG. 7 is a second illustration showing values to be written to the ascending/descending order setting register according to the first embodiment;

FIG. 8 is an illustration showing values to be written to a setup confirmation register according to the first embodiment;

FIG. 9 is an illustration showing a list of set values of the setup confirmation register according to the first embodiment;

FIG. 10 is a first circuit block diagram for describing an interface setting method for a semiconductor integrated circuit according to a second embodiment of the present invention;

FIG. 11 is a time chart of a clock for operating a CPU, and an address/data to be outputted therefrom in the second embodiment;

FIG. 12 is a second circuitry diagram for describing the interface setting method for a semiconductor integrated circuit according to the second embodiment of the present invention;

FIG. 13 is a circuitry diagram showing the inside of a device of the semiconductor integrated circuit according to the second embodiment of the present invention;

FIG. 14 is a connection diagram of a semiconductor integrated circuit, when a CPU and a device having the same bus type and the same endian type are connected;

FIG. 15 is a first connection diagram of a semiconductor integrated circuit, which illustrates a conventional case where a CPU and a device having the same bus type and different data endian type are connected;

FIG. 16 is a second connection diagram of a semiconductor integrated circuit, which illustrates a conventional case where a CPU and a device having the same bus type and different data endian type are connected;

FIG. 17 is a third connection diagram of a semiconductor integrated circuit, which illustrates a conventional case where a CPU and a device having the same bus type and different data endian type are connected;

FIG. 18 is a connection diagram of a semiconductor integrated circuit, which illustrates a conventional case where a CPU and a device having the different bus types and the same data endian type are connected; and

FIG. 19 is a connection diagram of a semiconductor integrated circuit, which illustrates a conventional case where a CPU and a device having different bus types and different data endian types are connected.

### DETAILED DESCRIPTION OF THE INVENTION

Hereinafter, embodiments of an interface setting method according to the present invention will be described in detail referring to the accompanying drawings.

### First Embodiment

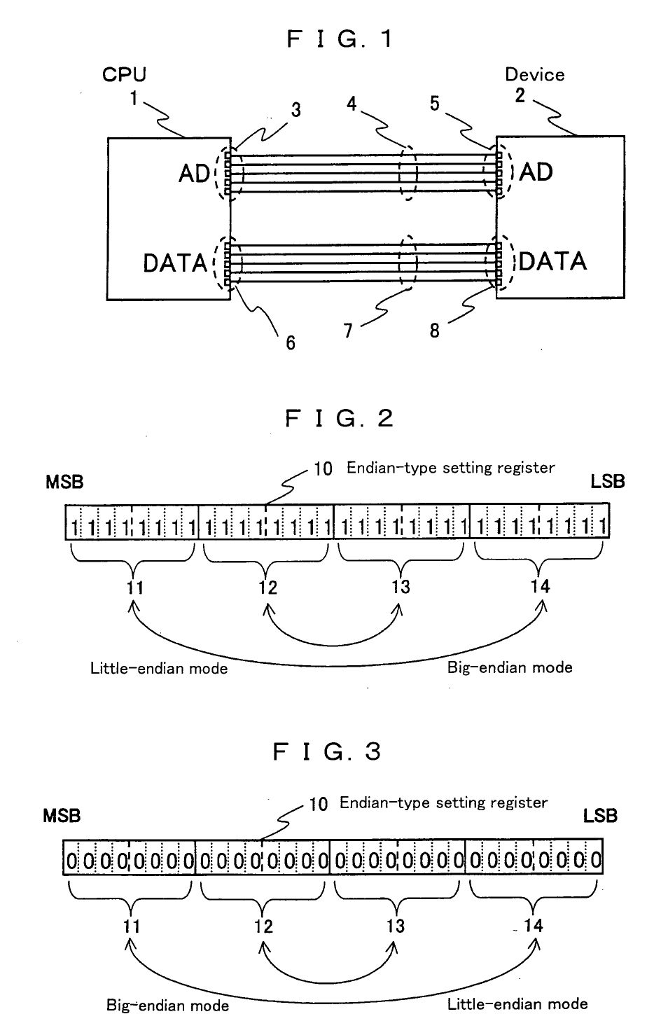

FIG. 1 is a circuitry diagram for describing the interface setting method for a semiconductor integrated circuit according to a first embodiment of the present invention. In FIG. 1, reference numeral 1 is a CPU (a typical example of processor) whose bus type is a separate type, 2 is also a separate-type device that is controlled by the CPU 1, 3 indicates address output terminals of the CPU 1, 4 indicates address signal lines on a substrate, 5 indicates address input terminals of the device 2, 6 indicates data input/output terminals of the CPU 1, 7 indicates data signal lines on the substrate, and 8 indicates data input/output terminals of the device. In general, in the connection between the CPU and the device, there are, for example, enabling signals, interrupt signals, acknowledge signals or the like, other than the address signals and the data signals. However, those other than the address signals and the address signals are omitted here.

If the data endian types of the CPU 1 and the device 2 are the same, there is no problem in terms of connection without taking any special measures. However, when the data endian types or the arranging orders of the nibbles are different between the CPU 1 and the device 2, it is necessary to connect the data signal lines on the substrate in a crosswise manner at a unit of byte or a unit of nibble, as shown in FIG. 15. In order to avoid it, in this embodiment, an endian-type setting register is provided, and set values are written thereto to set the endian type. Accordingly, the CPU 1 and the device 2 can be connected, considering that their endian types are not different.

A specific example will be described referring to FIG. 2 and FIG. 3. FIG. 2 and FIG. 3 are illustrations showing the values to be written to an endian-type setting register. In FIG. 2 and FIG. 3, reference numeral 10 is the endian-type setting register to which the set values for setting the endian type are written, 11 indicates the most-significant byte in the endian-type setting register 10, 12 indicates the second-most-significant byte, 13 indicates the second-least-significant byte, and 14 indicates the least-significant byte. This endian-type setting register 10 is provided inside the device 2.

In a case where it is desirable to change the endian type of the device 2, such values are written to the endian-type setting register 10 that the values in the entire register do not change even if the arranging order of the high-order byte and low-order byte changes. For example, FIG. 2 illustrates the case where a value “1” is written to all the bits. In this case, even if the most-significant byte 11 and the least-significant byte 14, and the second byte from the most-significant 12 and the second byte from the least-significant 13 are counterchanged, the values in the endian-type setting register 10 do not change. By being equipped with a circuit that turns to big-endian mode to the device 2 when such values are written to the endian-type setting register 10, the device 2 can be switched from the little-endian device to a big-endian device.

FIG. 3 illustrates the register that has values different from those in the register described in FIG. 2. In FIG. 3, a value “0” is written to all the bits in the endian-type setting register 10. In this case, the values in the endian-type setting register 10 do not change either, even if the most-significant byte 11 and the least-significant byte 14, and the second-most significant byte 12 and the second-least significant byte 13 are switched. By providing, to the device 2, a circuit that turns to little-endian mode when such values are written to the endian-type setting register 10, the device 2 can be switched from the big-endian device to a little-endian device.

In this manner, it is possible to switch the endian type of data between the little-endian mode and big-endian mode, based on data array set in the endian-type setting register 10.

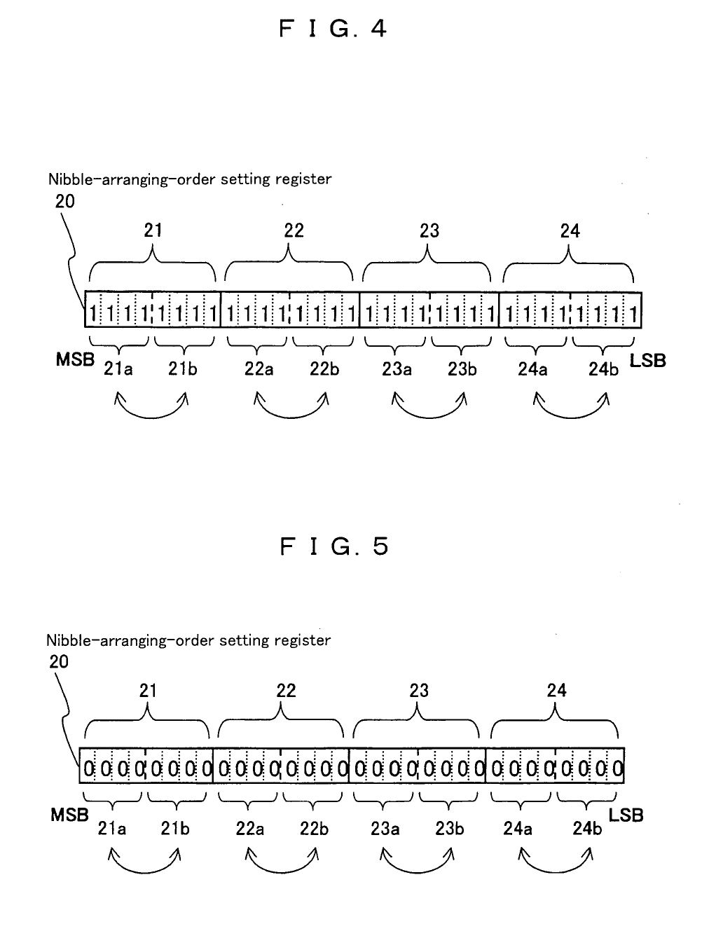

Next, the example in a case of setting the arranging order of the nibbles in data will be described. FIG. 4 and FIG. 5 show nibble-arranging-order setting registers for carrying out setup to counterchange the arranging order of the nibbles. In FIG. 4, reference numeral 20 is a nibble-arranging-order setting register for setting the arranging order of the nibbles in data, 21 indicates the most-significant byte in the nibble-arranging-order setting register 20, 22 indicates the second byte from the most-significant, 23 indicates the second byte from the least-significant, and 24 indicates the least-significant byte. 21a indicates the high-order nibble of the most-significant byte 21, 21b is the low-order nibble thereof, 22a indicates the high-order nibble of the second byte from the most-significant 22, 22b is the low-order nibble thereof, 23a indicates the high-order nibble of the second byte from the least-significant 23, 23b is the low-order nibble thereof, 24a indicates the high-order nibble of the least-significant byte 24, and 24b is the low-order nibble thereof. This nibble-arranging-order setting register 20 is provided inside the device 2.

In case of changing the arranging order of the nibbles, the high-order nibble and the low-order nibble are counterchanged in each byte of the data. FIG. 4 illustrates the case where a value “1” is written to all the bits of the data. In this case, the values of the data as a whole do not change even if the arranging order of the nibbles in each byte of the data is changed. That is, the values in the register as a whole do not change even if the nibble 21a and the nibble 21b, the nibble 22a and the nibble 22b, the nibble 23a and the nibble 23b, and the nibble 24a and the nibble 24b are counterchanged, respectively. By being equipped with a circuit, in which the high-order nibble and the low-order nibble of each byte counterchanges, to the device 2 when such values are written to the nibble-arranging-order setting register 20, it is possible to change the arranging order of the nibbles in the device 2 through software, even if the arranging order of the nibbles in the bytes of the data are different between the CPU 1 and the device 2.

FIG. 5 illustrates the register that has values different from those in the register described in FIG. 4. In FIG. 5, a value “0” is written to all the bits in the nibble-arranging-order setting register 20. In this case, the values in the register as a whole do not change either, even if the nibble 21a and the nibble 21b, the nibble 22a and the nibble 22b, the nibble 23a and the nibble 23b, and the nibble 24a and the nibble 24b are counterchanged, respectively. By setting the nibbles of the data in the device 2 so as to be unchanged when such values described above, which are different from the values to be written in setting to counterchange the nibbles, are written to the nibble-arranging-order setting register 20, it becomes possible to select whether or not to switch the arranging order of the nibbles through software in combination with the one described in FIG. 4.

In this manner described above, it is possible to counterchange the arranging order of the nibbles of the data or to return it to the original state, based on the data array set in the nibble-arranging-order setting register 20.

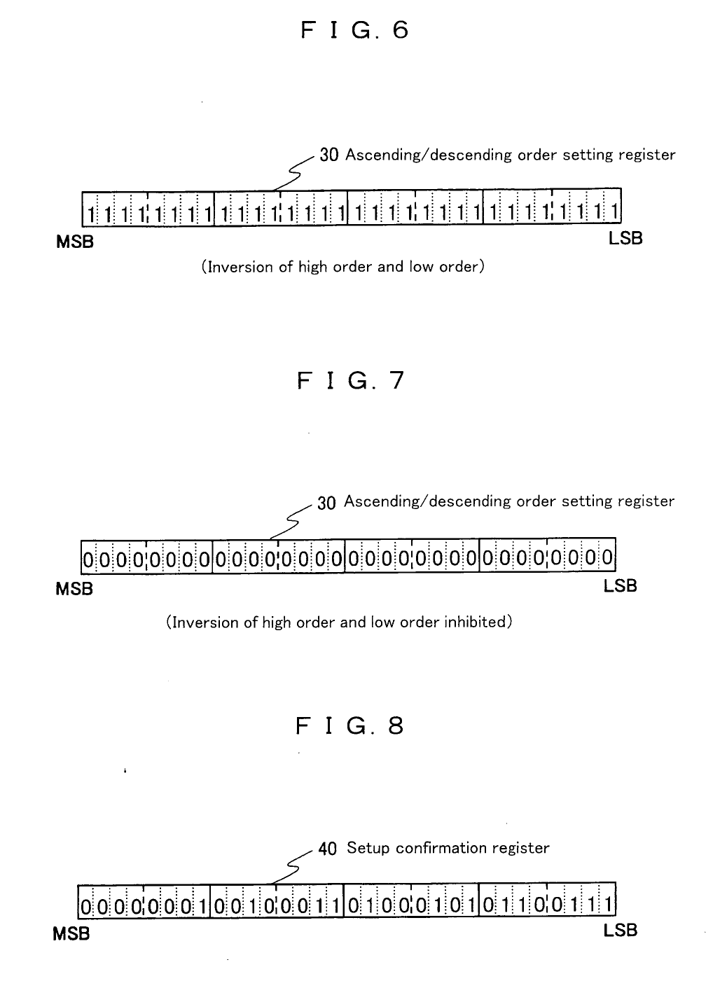

Next, a method for counterchanging the high order and the low order of the data will be described. FIG. 6 and FIG. 7 shows the setup states of an ascending/descending order setting register that carries out the setting for counterchanging the high order and the low order of the data. In FIG. 6, reference numeral 30 is the ascending/descending order setting register for carrying out the setting for counterchanging the high order and the low order of the data. This ascending/descending order register 30 is provided inside the device 2. FIG. 6 illustrates the case where a value “1” is written to all the bits of the data. By being equipped with a circuit in which the high order and the low order of the data are inversed, to the device 2 when the data array, in which the values of the data as a whole doe not change even if the high order and the low order of the data is changed, is written to the ascending/descending order setting register 30, it is possible to inverse the high order and the low order of the data in the CPU 1 and the device 2 based on the setting of the register. Adversely, when the high order and the low order of the data are not desired to be inversed, the device 2 may be equipped with a circuit, that operates not to inverse the high order and the low order of the data, to the ascending/descending order register, by writing values that are not for inversing the high order and the low order of the data, as shown in FIG. 7.

In addition, it is assumed here that these endian-type setting register 10, nibble arranging-order setting register 20 and ascending/descending order setting register 30 used for setting are out of the targets for the so-called software reset that is to initialize the device through software. They can be initialized only by hardware reset.

Next, a setup confirmation register, that checks the current setting state, will be described referring to FIG. 8. Here, at least two registers are used as the interface specification setting register, among the endian-type setting register for setting the endian type of the data, the nibble arranging-order setting register for setting the arranging order of the nibbles of the data, and the ascending/descending order setting register for setting the ascending/descending order of the bits of the data. Further, when the values of at least two registers mentioned above are changed, the setup confirmation register sets values that are not consistent with each other in accordance with the changes in the values of the two registers, and maintains those values even under the hardware reset and software reset. Hereinafter, the detail will be described.

In FIG. 8, reference numeral 40 is the setup confirmation register. This setup confirmation register 40 is provided inside the device 2. It is assumed herein that values “0000 0001 0010 0011 0100 0101 0110 0111” (“01234567” in hexadecimal numeral) are set in the setup confirmation register 40 as an example. When the values is read out from the setup confirmation register 40, the values in the original state, “0000 0001 0010 0011 0100 0101 0110 0111” (“01234567” in hexadecimal numeral) are read out in a case where none of the actions for switching the endian types, switching the arranging order of the nibbles of the data, and inversion of the high order and low order of the data is carried out.

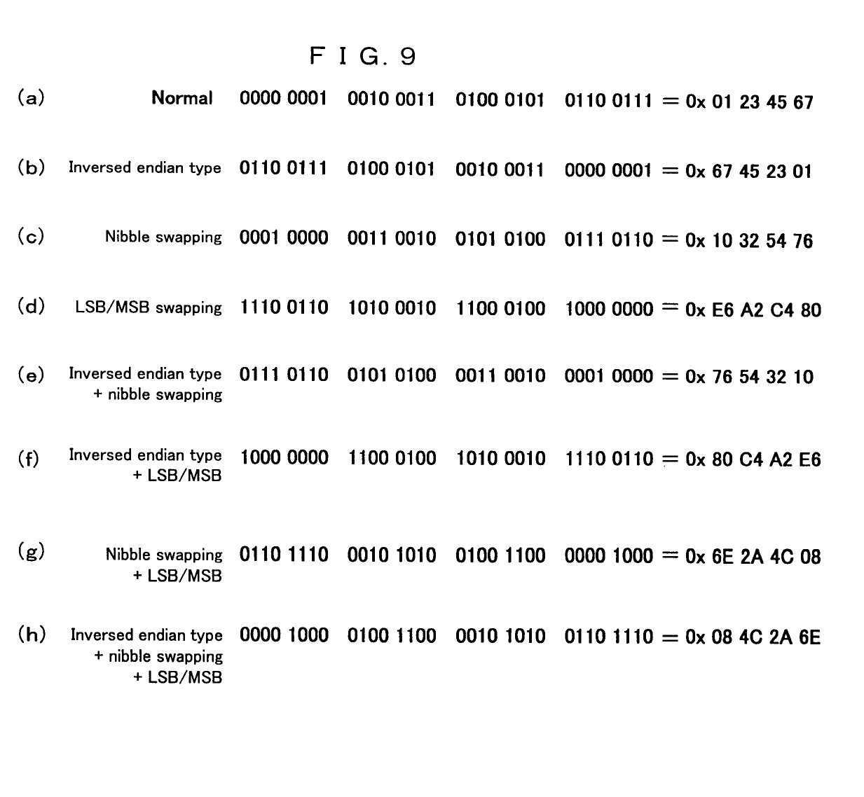

FIG. 9 shows a list of the values of the setup confirmation register 40, which is read out based on the setting. As shown in (b) of FIG. 9, when the endian type is switched (reversed endian type), the values of the setup confirmation register 40 are read out as “0110 0111 0100 0101 0010 0011 0000 0001” that is “67452301” in the hexadecimal numeral. As shown in (c) of FIG. 9, when the nibbles are inversed (nibble swapping), the values of the setup confirmation register 40 are read out as “0001 0000 0011 0010 0101 0100 0111 0110” that is “10325476” in the hexadecimal numeral. As shown in (d) of FIG. 9, when the high order and the low order of the data are inversed (LSB/MSB swapping), the values of the setup confirmation register 40 are read out as “1110 0110 1010 0010 1100 0100 1000 0000” that is “E6A2C480” in the hexadecimal numeral. As shown in (e) of FIG. 9, when switching of the endian type (reversed endian type) and inversion of the nibbles (nibble swapping) are carried out simultaneously, the values of the setup confirmation register 40 are read out as “0111 0110 0101 0100 0011 0010 0001 0000” that is “76543210” in the hexadecimal numeral. As shown in (f) of FIG. 9, when switching of the endian type (reversed endian type) and inversion of the high order and low order of the data (LSB/MSB swapping) are carried out, the values of the setup confirmation register 40 are read out as “1000 0000 1100 0100 1010 0010 1110 0110” that is “80C4A2E6” in the hexadecimal numeral. As shown in (g) of FIG. 9, when inversion of the nibbles (nibble swapping) and inversion of the high order and low order of the data (LSB/MSB swapping) are carried out, the values of the setup confirmation register 40 are read out as “0110 1110 0010 1010 0100 1100 0000 1000” that is “6E2A4C08” in the hexadecimal numeral. As shown in (h) of FIG. 9, when switching of the endian type (reversed endian type), inversion of the nibbles (nibble swapping), and inversion of the high order and low order of the data (LSB/MSB swapping) are carried out, the values of the setup confirmation register 40 are read out as “0000 1000 0100 1100 0010 1010 0110 1110” that is “084C2A6E” in the hexadecimal numeral.

As described above, by being equipped with the setup confirmation register, that reads out different values in all of the settings, to the device 2, it is possible to judge the current setting state by reading out the values. Further, this setup confirmation register should be a register to which writing is prohibited, and it is necessary that the values therein do not change even when it is initialized through hardware reset or software reset.

### Second Embodiment

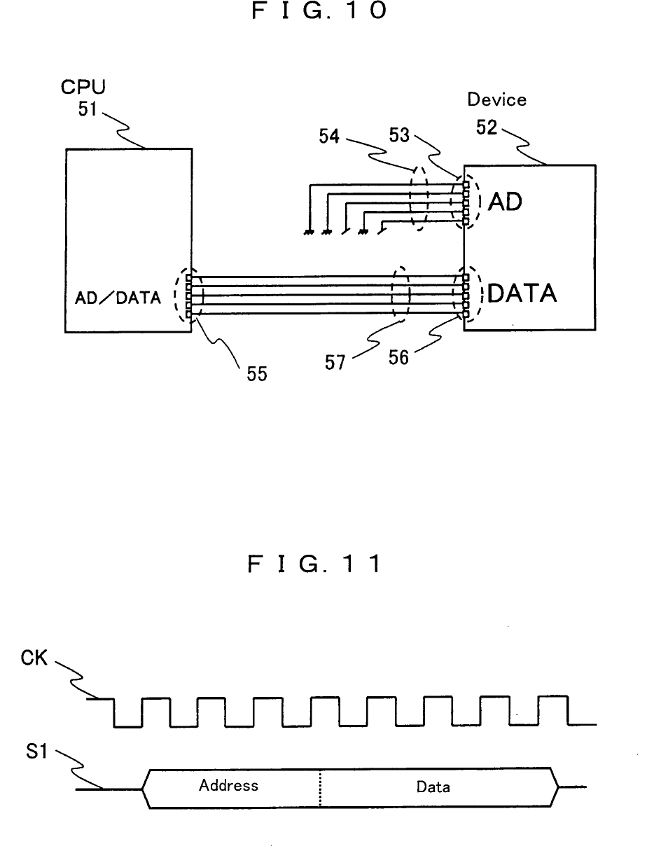

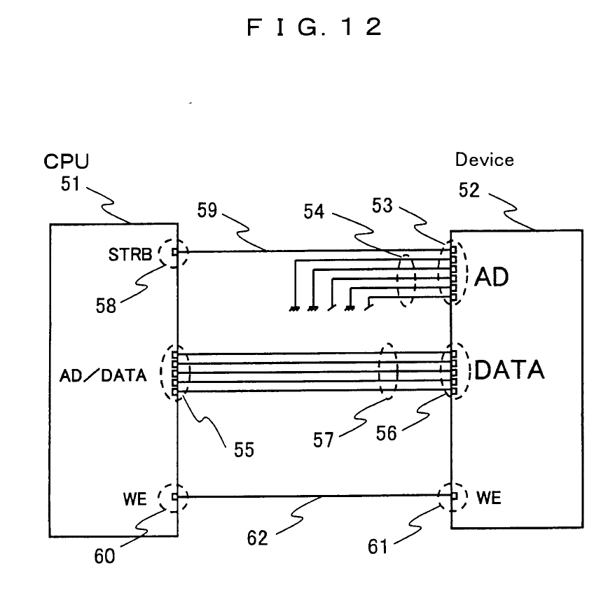

FIG. 10 is a circuitry diagram for describing the interface setting method according to a second embodiment of the present invention. In FIG. 10, reference numeral 51 is a CPU, 52 is a device that is controlled by the CPU 51, 53 indicates address input terminals of the device 52, 54 indicates address input signal lines that are connected to the address input terminals 53, 55 indicates address/data input/output terminals of the CPU 51, 56 indicates data input/output terminals of the device 52, and 57 indicates signal lines for connecting the address/data input/output terminals 55 and the data input/output terminals 56. Through the address/data input/output terminals 55 of the CPU 51, the address and the data are inputted and outputted as the shared signals. The CPU 51 that operates in this way is a multiplex-type CPU, and the address and the data are outputted as shown in FIG. 11.

FIG. 11 is a time chart of a clock for operating the CPU, and the address/data to be outputted therefrom. In FIG. 11, CK is the clock for operating the CPU 51, S1 is the address and the data signal appeared at the address/data input/output terminals 55. In general, as indicated in the signal S1, the address/data input/output signal of the multiplex-type CPU outputs the address as much as the several cycles of the clock CK and, thereafter, inputs/outputs the data as much as the several cycles of the clock CK.

In this embodiment, the device 52 that is connected to such multiplex-type CPU 51 is equipped with a bus-type setting register for selecting whether the bus type is made the separate type or multiplex type. In the device 52, the address input terminals 53 and the data input/output terminals 56 are separated, so that it is assumed for the so-called separate-type CPU to be connected.

By writing the values for selecting the multiplex type onto the bus-type setting register in the device 52, it is possible to switch the bus type to the multiplex type. In setting the device 52 as the multiplex-type device, the address input terminals 53 are fixed to the address of the bus-type setting register through the address input signal lines 54. According to this, all of the address/data input values inputted from the data input/output terminals 56 are written to the bus-type setting register. Then, the setting values for switching the bus type are outputted from the address/data input/output terminals 55 through the control of the software, and the values are written to the bus-type setting register. By doing so, the bus type of the device 52 can be switched.

Additionally, the multiplex-type CPU normally outputs an address strobe signal for informing the device connected thereto that the address is outputted from the address/data input/output terminals, and the signal level is changed while the address is outputted from the CPU. Further, when the CPU writes some kinds of values onto the device connected thereto, the CPU outputs a writing request signal (referred to as a writing enabling signal hereinafter) to inform the connected device that it is a writing operation. Connection between the CPU and the device will be described referring to FIG. 12 in case of using those address strobe signal and writing enabling signal.

FIG. 12 shows another circuitry diagram of the interface setting method according to the second embodiment of the present invention. In FIG. 12, reference numeral 51 is a CPU of the multiplex-type, 52 is a device that is controlled by the CPU 51, 58 is the address-strobe-signal output terminal of the CPU 51, 53 indicates the address input terminals of the device 52, 59 is the output signal line of the address strobe signal, 54 indicates the address signal input lines, 55 indicates the address/data input/output terminals of the CPU 51, 56 indicates the data input/output terminals of the device 52, 57 indicates the data signal lines, 60 is a writing-enabling-signal output terminal of CPU 51, 61 is a writing-enabling-signal input terminal of the device 52, and 62 is a writing enabling signal line.

The address-strobe-signal output terminal 58 is connected to one of the address input terminals 53 through the output signal line 59. The address/data input/output terminals 55 are connected to the data input/output terminals 56 through the data signal lines 57. The writing-enabling-signal output terminal 60 is connected to the writing-enabling-signal input terminal 61 through the writing enabling signal line 62.

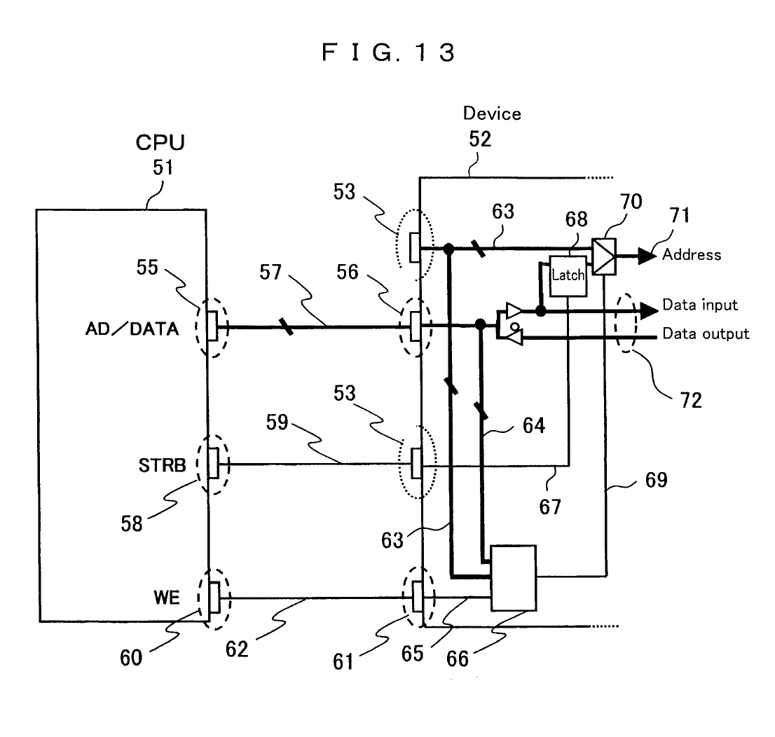

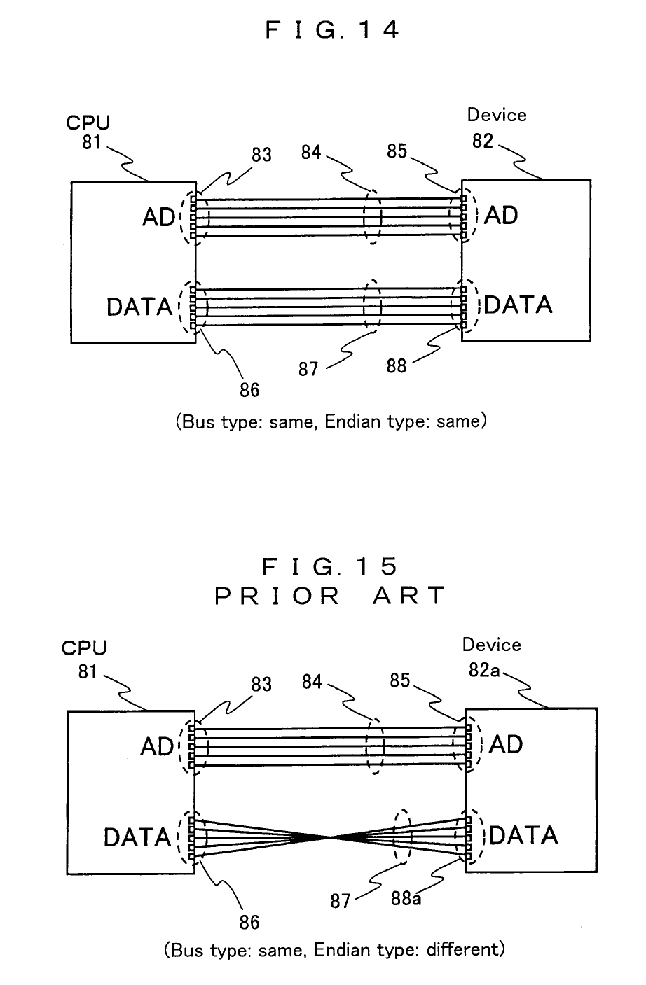

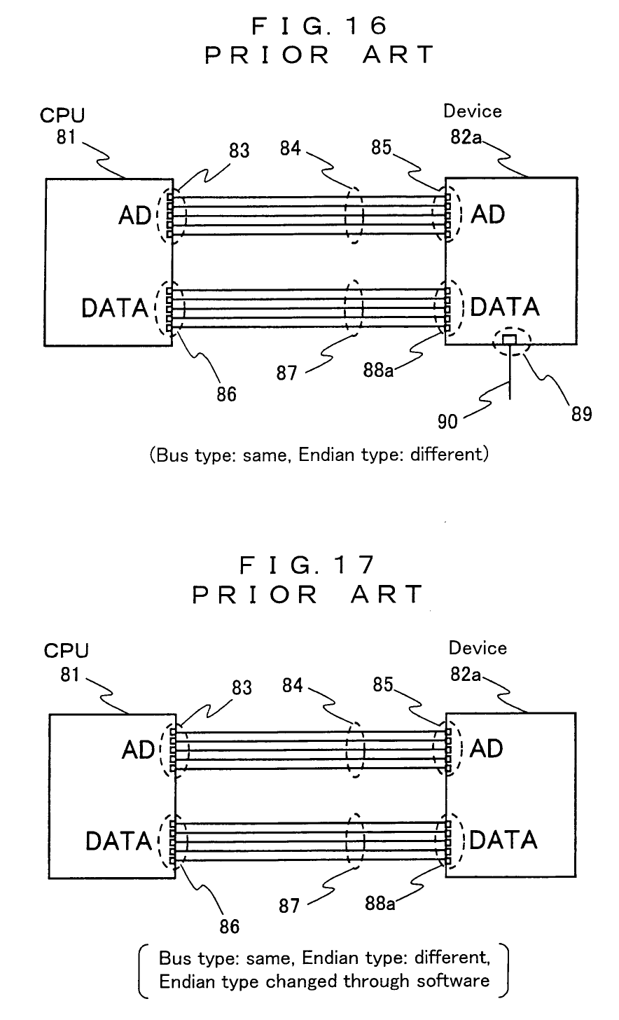

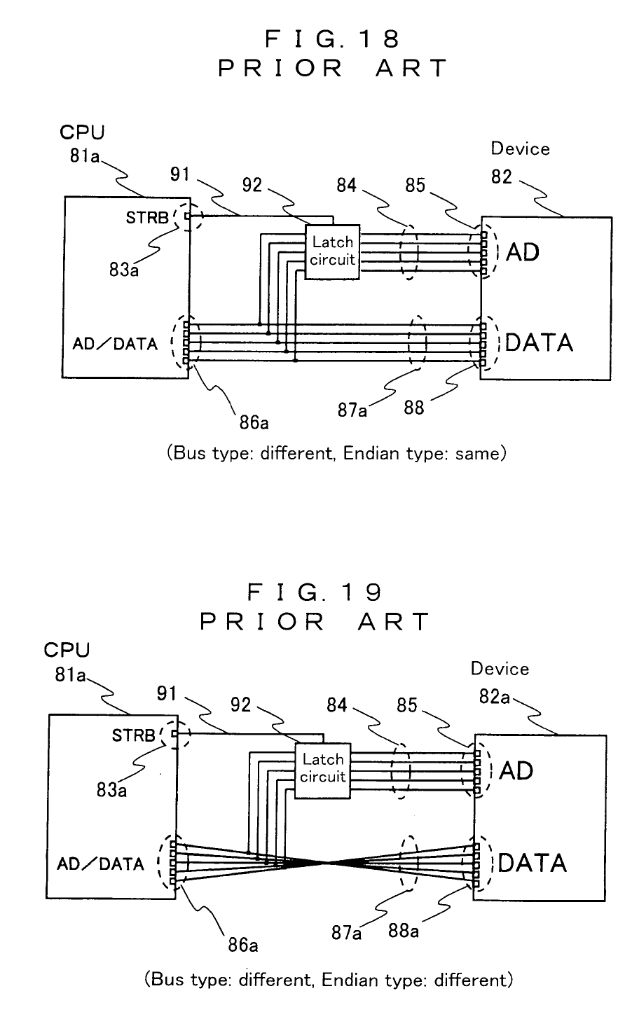

FIG. 13 shows an example of the specific inside structure of the device 52. In FIG. 13, reference numeral 63 is an inside address signal line, 64 is an inside address/data signal line, 65 is an inside writing enabling signal line, 66 is a bus-type setting register for setting the bus type of the device 52 to either the separate type or the multiplex type, 67 is an inside address strobe signal line, 68 is a latch circuit for latching the address part from the address/data signal line 64, 69 is an output signal line of the bus-type setting register 66, 70 is a selector for selecting either the value of the address signal 63 or the output value of the latch circuit 68 as the address signal to be used inside, 71 is an address signal line used inside, and 72 indicates the section for inserting the device for counterchanging the endian type, the arranging order of the nibbles and the ascending/descending order of the bits of the data.

The values of both the data and address are transmitted to the address/data signal line 64 from the multiplex-type CPU 51. The address strobe signal outputted from the address-strobe-signal output terminal 58 is introduced to the address strobe signal line 67 of the device 52. When the value of the address strobe signal line 67 changes to a value indicating that the CPU 51 has outputted the address, the latch circuit 68 latches and keeps the address value from the address/data signal line 64. When the device 52 is used as the multiplex type, a bit that is irrelevant for designating the address of the bus-type setting register is used as the address strobe signal outputted from the CPU 51. It will be described in detail hereinafter.

For switching the device 52 to the multiplex type, the values of the address input terminals 53 are fixed to values for designating the address of the bus-type setting register 66. The values of the address input terminals 53 are inputted to the bus-type setting register 66 through the address signal line 63. That is, the address of the bus-type setting register. 66 is designated with priority.

When the value of the writing enabling signal line 65 indicates a writing request, the bus-type setting register 66 fetches the value of the address/data signal line 64. At this time, if the fetched value indicates a change to the multiplex type, the bus-type setting register 66 outputs a value for switching the selector 70 to the output signal line 69. As a result, the selector 70 selects the output of the latch circuit 68. The output of the latch circuit 68 is the address outputted from the address/data input/output terminals 55.

Meanwhile, when the fetched value indicates a change to the separate type, the bus-type setting register 66 switches the selector 70 to the separate type and the selector 70 selects the value of the address signal line 63.

Among the address input terminals 53, those other than the address strobe input are fixed in the outside of the device 52, so that the bus-type setting register 66 is under a state of designating the address at all times. That is, the values changing chronologically in the address/data signal line 64 are applied to the input of the bus-type setting register 66 at all times. In the meantime, once the bus-type setting register 66 instructs change to the multiplex type, the bus-type setting register 66 cannot change the values with any other ways than hardware reset. It is to avoid such inconvenience that the values of the bus-type setting register 66 are changed every time the CPU 51 carries out data access to the device 52. Thus, the selector 70 is always fixed to the state for selecting the latch circuit 68.

Furthermore, by setting the values of the endian-type setting register, the nibble arranging-order setting register and-the ascending/descending order setting register after changing the device 52 to the multiplex type, it is possible: to connect the device 52 to all kinds of existing CPUs.

It is assumed here that the endian-type setting register, the nibble arranging-order setting register and the ascending/descending order setting register are inserted to the point 72 that is further at the rear of the branch point of the latch circuit 68, because the address value latched by the latch circuit 68 is also changed if it is inserted right after the address/data input/output terminal 56.

The present invention has been described in detail referring to the most preferred embodiments. However, various combinations and modifications of the components are possible without departing from the spirit and the broad scope of the appended claims.

What is claimed is:

1. An interface setting method for setting interface specifications between a processor and a device that is controlled by said processor, said device having a plurality of kinds of interface specifications, wherein:
an interface-specification setting register is provided to said device; a prescribed interface specification is set in said interface-specification setting register by software control through said processor; and, thereafter, said device is operated with said interface specification that is set in said interface-specification setting register.

2. The interface setting method according to claim 1, wherein:
an endian-type setting register that sets an endian type of data as said interface specification is used as said interface-specification setting register; and said endian type is set in said endian-type setting register through software control performed based on data access of said processor.

3. The interface setting method according to claim 2, wherein:
setting of said endian type is carried out by writing data array, that is not affected by said endian type, to said endian-type setting register.

4. The interface setting method according to claim 1, wherein:
a nibble-arranging-order setting register that sets nibble arranging order of data as said interface specification is used as said interface-specification setting register; and said nibble arranging order is set in said nibble-arranging-order setting register through software control performed based on data access of said processor.

5. The interface setting method according to claim 4, wherein:
setting of said nibble arranging order of data is carried out by writing data array, that is not affected by said nibble arranging order, to said nibble-arranging-order setting register.

6. The interface setting method according to claim 1, wherein:
an ascending/descending order setting register that sets ascending/descending order of bits of data as said interface specification is used as said interface-specification setting register; and said ascending/descending order of bits of data is set in said ascending/descending order setting register through software control performed based on data access of said processor.

7. The interface setting method according to claim 6, wherein:
setting of said ascending/descending order of bits of data is carried out by writing data array, that is not affected by said ascending/descending order of bits, to said ascending/descending order setting register.

8. The interface setting method according to claim 1, wherein:
a bus-type setting register that sets bus type of address/data as said interface specification is used as said interface-specification setting register; and said bus type of address/data is set in said bus-type setting register through software control performed based on data access of said processor.

9. The interface setting method according to claim 8, wherein:
an arbitrary register having an address that can be expressed by eliminating a bit from an address signal width of said device as said interface specification is used as said bus-type setting register; and
a data array for setting a bus type of said device to either a separate type or a multiplex type is written to said bus-type setting register.

10. The interface setting method according to claim 9, wherein, when said bus type is set to said multiplex type in said bus-type setting register, set value thereof is kept in said bus-type setting register and update of said set value is carried out thereafter only with hardware reset.

11. The interface setting method according to claim 9, wherein, when said device is used as said multiplex type, a bit that is irrelevant to designation of address of said bus-type setting register is used as an address strobe signal outputted by said processor.

12. The interface setting method according to claim 1, wherein, said interface-specification setting register is precluded any possibility of target of a software reset function; and a set value of said interface-specification setting register is changed by hardware reset or overwriting said value.

13. The interface setting method according to claim 1, wherein, a set value in said interface-specification setting register is confirmed by using a setup confirmation register of said device.

14. The interface setting method according to claim 13, wherein:
as said interface-specification setting register, at least two registers are used among said endian-type setting register for setting said endian type of data, said nibble-arranging-order setting register for setting said nibble arranging order of data and said ascending/descending order setting register for setting said ascending/descending order of bits of data; and when said values of said at least two registers are changed, said setup confirmation register sets values that are not consistent with each other in accordance with changes in said values of said at least two registers, and keeps said set values even under hardware reset and software reset.
